(19) United States
(12) Patent Application Publication
(10) Pub. No.: US 2016/0165927 A1
(43) Pub. Date: Jun. 16, 2016

(54) METHODS AND COMPOSITIONS FOR PROMOTING LEAN BODY MASS AND MINIMIZE BODY FAT GAIN AND MANAGING WEIGHT

(71) Applicant: Nestec SA, Vevey (CH)

(72) Inventors: Yuanlong Pan, Chesterfield, MO (US); Xui Xu, Chesterfield, MO (US); Sandeep Bhatnagar, Ballwin, MO (US)

(21) Appl. No.: 14/946,205

(22) Filed: Nov. 19, 2015

Related U.S. Application Data
(60) Provisional application No. 62/084,233, filed on Nov. 25, 2014.
(60) Provisional application No. 62/086,402, filed on Dec. 2, 2014.

(51) Int. Cl. A23K 1/16; A23K 1/18; A23L 1/29

(52) U.S. Cl. CPC A23K 1/1846; A23K 1/1643; A23K 1/1631; A23K 1/164

(57) ABSTRACT

The invention provides compositions and methods for promoting lean body mass, minimizing body fat gain, and managing weight in an animal. The methods for promoting lean body mass, minimizing body fat gain, and maintaining weight without limiting caloric intake comprise administering to the animal a food composition in an amount more than the animal's baseline maintenance energy requirement (MER). The food composition can comprise from about 30% to about 65% protein, from about 10% to about 20% carbohydrate, and from about 10% to about 25% fat. The protein and carbohydrate can be in a ratio effective for promoting lean body mass, minimizing body fat gain, and maintaining weight during administration of the food composition to the animal.

### CROSS REFERENCE TO RELATED APPLICATIONS

This application claims priority to U.S. Provisional Application Ser. No. 62/084,233 filed Nov. 25, 2014 and to U.S. Provisional Application Ser. No. 62/086,402 filed Dec. 2, 2014, the disclosures of both of which are incorporated in therein entireties herein by this reference.

### BACKGROUND OF THE INVENTION

1. Field of the Invention

The invention relates generally to methods and compositions for promoting lean body mass, minimizing body fat gain, and managing weight in an animal.

2. Description of Related Art

Obese and overweight animals have an increased risk of many chronic diseases including heart disease, diabetes, hypertension, stroke, dyslipidemia, certain types of cancer, apnea and osteoarthritis. Therefore it is essential for animals, including humans and pets, to maintain ideal weight and promote lean body mass without excessive accumulation of body fat to maintain health and quality of life. Unfortunately, it is very difficult for people and animals to consume exact amount of calories that meet their maintenance requirement to prevent excessive accumulation of body fat, and maintain lean body mass which is important for normal metabolism, physical performance, and health.

Obesity is among the most serious health problems in humans and pets and considered to be the leading preventable cause of death. Maintaining ideal body weight, minimizing body fat gain, and maintaining lean body mass is critical for optimal metabolism, normal physical activity and good health. There is, therefore, a need for methods and compositions useful for promoting the health and wellness and improving the quality of life for animals by promoting lean body mass, minimizing body fat gain, and managing weight.

### SUMMARY OF THE INVENTION

It is, therefore, an object of the present invention to provide methods and compositions useful for promoting lean body mass, minimizing body fat gain, and managing weight in an animal.

It is another object of the invention to provide methods for promoting the health and wellness of animals.

It is another object of the invention to provide methods for extending the prime years of an animal's life.

One or more of these or other objects can be achieved by administering a food composition to an animal in therapeutically effective amounts for promoting lean body mass, minimizing body fat gain, and managing weight.

In one embodiment, a method for promoting lean body mass, minimizing body fat gain, and maintaining weight without limiting caloric intake comprise administering to the animal a food composition, as described herein, in an amount more than the animal's baseline maintenance energy requirement (MER).

In another embodiment, the food composition can comprise from about 30% to about 65% protein, from about 10% to about 20% carbohydrate, and from about 10% to about 25% fat.

Generally, the protein and carbohydrate can be in a ratio effective for promoting lean body mass, minimizing body fat gain, and maintaining weight during administration of the food composition to the animal.

Other and further objects, features, and advantages of the invention will be readily apparent to those skilled in the art.

### DETAILED DESCRIPTION OF THE INVENTION

### Definitions

The term “animal” means any animal that has a need for preserving or promoting lean body mass during weight loss, including human, avian, bovine, canine, equine, feline, hicrine, lupine, murine, ovine, or porcine animals. In one aspect, the animal can be a mammal.

The term “companion animal” means domesticated animals such as cats, dogs, rabbits, guinea pigs, ferrets, hamsters, mice, gerbils, horses, cows, goats, sheep, donkeys, pigs, and the like. In one aspect, the companion animal can be a canine. In another aspect, the companion animal can be a feline.

The term “therapeutically effective amount” means an amount of a compound of the present invention that (i) treats or prevents the particular disease, condition, or disorder, (ii) attenuates, ameliorates, or eliminates one or more symptoms of the particular disease, condition, or disorder, or (iii) prevents or delays the onset of one or more symptoms of the particular disease, condition, or disorder described herein.

The term “maintenance energy requirement” or “MER” or “baseline maintenance energy requirement” means the minimum amount of a food composition that is needed to sustain the weight of an animal. In one embodiment, the MER can be determined over a period of 1 to 12 weeks using feeding trial; or indirect or direct calorimetry. Non-calorimetric methods can also be used.

The terms “treating”, “treat”, and “treatment” embrace both preventative, i.e., prophylactic, and palliative treatment.

The term “health and/or wellness of an animal” means the complete physical, mental, and social well-being of the animal, not merely the absence of disease or infirmity.

The term “extending the prime” means extending the number of years an animal lives a healthy life and not just extending the number of years an animal lives, e.g., an animal would be healthy in the prime of its life for a relatively longer time.

The term “in conjunction” means that the food composition, components thereof, or other compositions of the invention are administered to an animal (1) together in a single food composition or (2) separately at the same or different frequency using the same or different administration routes at about the same time or periodically. “Periodically” means that the food composition, components thereof, or other compositions are administered on a schedule acceptable for specific compounds or compositions. “About the same time” generally means that the food composition, components thereof, or other compositions are administered at the same time or within about 72 hours of each other.

The term “obese” means a medical condition in which excess body fat has accumulated to the extent that it may have an adverse effect on health. Body mass index (BMI), a measurement which compares weight and height, defines individuals as obese when it is greater than 30 kg/m². Dogs and cats are classified as obese when their body weight is 30% higher than their ideal body weight.

The term “overweight” means having more body fat than is optimally healthy. Individuals are considered overweight if their BMI is between 25 kg/m² and 30 kg/m². Overweight is considered to be pre-obese. Dogs and cats are classified as overweight when their body weight is 15 to 29% higher than their ideal body weight.

The term “food” or “food product” or “food composition” means a product or composition that is intended for ingestion by an animal, including a human, and provides nutrition to the animal.

The term “regular basis” means at least monthly administration and, in one aspect, at least weekly administration. More frequent administration or consumption, such as twice or three times weekly, can be performed in certain embodiments. In one aspect, an administration regimen can comprise at least once daily consumption.

The term “single package” means that the components of a kit are physically associated in or with one or more containers and considered a unit for manufacture, distribution, sale, or use. Containers include, but are not limited to, bags, boxes, cartons, bottles, packages such as shrink wrap packages, stapled or otherwise affixed components, or combinations thereof. A single package may be containers of the food compositions, or components thereof, physically associated such that they are considered a unit for manufacture, distribution, sale, or use.

The term “virtual package” means that the components of a kit are associated by directions on one or more physical or virtual kit components instructing the user how to obtain the other components, e.g., in a bag or other container containing one component and directions instructing the user to go to a website, contact a recorded message or a fax-back service, view a visual message, or contact a caregiver or instructor to obtain instructions on how to use the kit or safety or technical information about one or more components of a kit.

The term “about” means plus or minus 20%; in one aspect, plus or minus 10%; in another aspect, plus or minus 5%; and in one specific aspect, plus or minus 2%.

As used herein, embodiments, aspects, and examples using “comprising” language or other open-ended language can be substituted with “consisting essentially of” and “consisting of” embodiments.

The term “complete and balanced” when referring to a food composition means a food composition that contains all known required nutrients in appropriate amounts and proportions based on recommendations of recognized authorities in the field of animal nutrition, and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO).

All percentages expressed herein are by weight of the composition on a dry matter basis unless specifically stated otherwise. The skilled artisan will appreciate that the term “dry matter basis” means that an ingredient's concentration or percentage in a composition is measured or determined after any free moisture in the composition has been removed.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a supplement”, “a method”, or “a food” includes a plurality of such “supplements”, “methods”, or “foods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, certain compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

The present methods and compositions are based upon the discovery that specific food compositions have been found to promote lean body mass, minimizing body fat gain, and manage weight in an animal without the need to restrict caloric intake. Surprisingly, such food compositions can be fed to the animal at an amount higher than the animal's baseline maintenance energy requirement (MER) without causing excessive weight gain, excessive body fat gain, and while promoting lean body mass. Generally, the present food compositions utilize a ratio of protein to carbohydrate that promotes lean body mass, minimizing body fat gain, and manages weight, including maintaining the weight of the animal, as compared to generic food compositions.

In accordance with these discoveries, in one embodiment, a method for promoting lean body mass, minimizing body fat gain, and maintaining weight without limiting caloric intake comprise administering to the animal a food composition, as described herein, in an amount more than the animal's baseline maintenance energy requirement (MER). The food composition can comprise from about 30% to about 65% protein, from about 10% to about 20% carbohydrate, and from about 10% to about 25% fat.

Generally, the protein and carbohydrate can be in a ratio effective for promoting lean body mass, minimizing body fat gain, and maintaining weight during administration of the food composition to the animal. Such ratios of protein to carbohydrate can range from about 4:1 to about 10:1. In one embodiment, the ratio of protein to carbohydrate ranges from about 4:1 to about 6:1. In one aspect, the ratio of protein to carbohydrate can be about 5:1.

Generally, the methods described herein can include one or all of the following steps: identifying an animal that has normal body weight and body fat, identifying an animal that is at risk for obesity or weight gain, identifying an overweight animal, determining the animal's MER, administering the present food compositions at an amount more than the MER such that the animal is satiated while promoting lean body mass, and minimizing body fat gain. In one embodiment, the step of determining the animal's MER can be achieved by measuring the minimal amount of calories that can maintain current body weight by indirect or direct calorimetry. In another embodiment, the MER can be provided by species, gender, breed, age etc. In one aspect, the animal can be a human and the MER can be determined by gender, age, and height. For example, for a human male, MER (kcal/day)=[662−(9.53×age)]+(15.91×body weight in kg)+(539.6×height in meter); and for a human woman, MER (kcal/day)=[(354−(6.91×age)]+(9.36×body weight in kg)+(726×height in meter). In another aspect, the animal can be a companion animal and the MER can be determined by breed and age. For example, MER (kcal/day) for a dog=139*(body weight in kg)^{0.75} and MER (kcal/day) for a cat=60*(body weight in kg). Determining an animal that is at risk for obesity or weight gain can include, without limitation, animals with a family history of obesity, animals having a health condition that limits or impairs the activity of the animal, animals having a health condition associated with obesity or weight gain, animals having a genetic predisposition of obesity, or animals having thyroid hormone, estrogen or androgen deficiency

The present methods provide effective weight management in that the animal can maintain weight and minimize body fat gain while promoting lean body mass. Promoting lean body mass can include increasing lean body mass or minimizing the loss of lean body mass and can be confirmed by measuring the lean body mass of the animal at baseline and measuring the lean body mass after the consumption of the present food compositions. The minimization of lean body mass can be a lean body mass loss of less than 5%, 4%, 3%, 2%, or even 1%. s In one specific aspect, no loss of lean body mass can be achieved, and in another aspect, an increase of lean body mass can be achieved. Additionally, minimizing body fat gain can include accumulating no more than 5%, 4%, 3%, 2%, or even 1% body fat during consumption of the food composition. In one aspect, minimizing body fat gain can include not gaining any body fat. Such promoting lean body mass, minimizing loss of lean body mass can be achieved while maintaining the animal's weight and minimizing body fat gain. Such effects can be seen during weight loss where the animal loses at least 10% body weight, or more. In one aspect, the effects can be seen with weight loss in smaller amounts including less than 10%, 5%, 3%, or even 1%.

The present methods include administering food compositions having components that are present in amounts that provide for effective promotion of lean body mass and effective weight management. As discussed herein, the present food compositions are generally administered in an amount at or more than the MER of the animal. In one embodiment, the amount of administered food composition can be from about 105% to 200% of the MER. In one aspect, the amount can be from about 110% to about 130% of the MER. Other amounts may be appropriate and can be determined based on the animal's initial weight as well as other variables such as species, gender, breed, age, desired weight loss, etc.

The administration can be performed on as-needed basis, an as-desired basis, a regular basis, or intermittent basis. In one aspect, the food composition can be administered to the animal on a regular basis. In one aspect, at least weekly administration can be performed. More frequent administration or consumption, such as twice or three times, or four times, or five times, or six times or seven times weekly, can be performed in certain embodiments. In one aspect, an administration regimen can comprise at least once daily consumption. In one aspect, an administration regimen can comprise periodic administration including at every other week, or every other two weeks, or every other three weeks, or every other month, or every other two months, every other three months, quarterly, every other quarterly, every other two quarterly, every other three quarterly etc.

According to the methods of the invention, administration, including administration as part of a dietary regimen, can span a period ranging from parturition through the adult life of the animal. In various embodiments, the animal can be a human or companion animal such as a dog or cat. In certain embodiments, the animal can be a young or growing animal. In other embodiments, administration can begin, for example, on a regular or extended regular basis, when the animal has reached more than about 10%, 20%, 30%, 40%, or 50% of its projected or anticipated lifespan. In some embodiments, the animal can have attained 40, 45, or 50% of its anticipated lifespan. In yet other embodiments, the animal can be older having reached 60, 66, 70, 75, or 80% of its likely lifespan. A determination of lifespan may be based on actuarial tables, calculations, estimates, or the like, and may consider past, present, and future influences or factors that are known to positively or negatively affect lifespan. Consideration of species, gender, size, genetic factors, environmental factors and stressors, present and past health status, past and present nutritional status, stressors, and the like may also influence or be taken into consideration when determining lifespan.

Such administration can be performed for a time required to accomplish one or more objectives of the invention, e.g., promoting lean body mass, minimizing body fat gain, and/or managing weight in an animal; improving the quality of life; and promoting the health and wellness in an animal.

Generally, a food composition for promoting lean body mass and managing weight can comprise from about 30% to about 65% protein, from about 10% to about 20% carbohydrate, and from about 10% to about 25% fat. As discussed herein, the protein and carbohydrate can be in a ratio effective for promoting lean body mass during administration of the food composition to an animal.

The protein can be crude protein material and may comprise plant proteins such as soybean meal, soy protein concentrate, corn gluten meal, wheat gluten, cottonseed, and peanut meal, or animal proteins such as casein, albumin, and meat protein. Examples of meat protein useful herein include beef, pork, lamb, equine, poultry, fish, and mixtures thereof. In one embodiment, the protein comprises about 45% to about 55% of the food composition

Generally, any type of carbohydrate can be used in the food compositions. Examples of suitable carbohydrates include grains or cereals such as rice, corn, millet, sorghum, alfalfa, barley, soybeans, canola, oats, wheat, rye, triticale and mixtures thereof. The compositions may also optionally comprise other materials such as dried whey and other dairy by-products. In one embodiment, the carbohydrate comprises about 10% to about 20% of the food composition.

Generally, the food compositions include fat. Examples of suitable fats include animal fats and vegetable fats. In one aspect, the fat source can be an animal fat source such as tallow or poultry fat. Vegetable oils such as corn oil, sunflower oil, safflower oil, grape seed oil, soy bean oil, olive oil and other oils rich in monounsaturated and polyunsaturated fatty acids, may also be used. In one embodiment, the fat comprises about 10% to about 20% of the food composition.

The moisture content for such food compositions varies depending on the nature of the food composition. The food compositions may be dry compositions (e.g., kibble), semi-moist compositions, wet compositions, or any mixture thereof. In one embodiment, the composition can be a pet food composition, and in one aspect, can be a complete and nutritionally balanced pet food. In this embodiment, the pet food may be a “wet food”, “dry food”, or food of “intermediate moisture” content. “Wet food” describes pet food that is typically sold in cans or foil bags and has a moisture content typically in the range of about 70% to about 90%. “Dry food” describes pet food that is of a similar composition to wet food but contains a limited moisture content typically in the range of about 5% to about 15% or 20% (typically in the form or small biscuit-like kibbles). In one embodiment, the compositions can have moisture content from about 5% to about 20%. Dry food products include a variety of foods of various moisture contents, such that they are relatively shelf-stable and resistant to microbial or fungal deterioration or contamination. Also, in one aspect, dry food compositions can be extruded food products for either humans or companion animals.

The food compositions may also comprise one or more fiber sources. The term “fiber” includes all sources of “bulk” in the food whether digestible or indigestible, soluble or insoluble, fermentable or nonfermentable. Such fibers can be from plant sources such as marine plants but microbial sources of fiber may also be used. A variety of soluble or insoluble fibers may be utilized, as will be known to those of ordinary skill in the art. The fiber source can be beet pulp (from sugar beet), gum arabic, gum talha, psyllium, rice bran, carob bean gum, citrus pulp, pectin, fructooligosaccharide, short chain oligofructose, mannanoligofructose, soy fiber, arabinogalactan, galactooligosaccharide, arabinoxylan, or mixtures thereof.

Alternatively, the fiber source can be a fermentable fiber. Fermentable fiber has previously been described to provide a benefit to the immune system of a companion animal. Fermentable fiber or other compositions known to skilled artisans that provide a prebiotic to enhance the growth of probiotics within the intestine may also be incorporated into the composition to aid in the enhancement of the benefit provided by the present invention to the immune system of an animal.

In some embodiments, the ash content of the food composition ranges from less than 1% to about 15%. In one aspect, the ash content can be from about 5% to about 10%.

Generally, the food composition can be suitable for consumption by an animal, including humans and companion animals such as dogs and cats, as a meal, component of a meal, a snack, or a treat. Such compositions can include complete foods intended to supply the necessary dietary requirements for an animal. Examples of such food compositions include but are not limited to dry foods, wet foods, drinks, bars, frozen prepared foods, shelf prepared foods, and refrigerated prepared foods.

Food compositions may further comprise one or more substances such as vitamins, minerals, antioxidants, probiotics, prebiotics, salts, and functional additives such as palatants, colorants, emulsifiers, and antimicrobial or other preservatives. Minerals that may be useful in such compositions include, for example, calcium, phosphorous, potassium, sodium, iron, chloride, boron, copper, zinc, magnesium, manganese, iodine, selenium, and the like. Examples of additional vitamins useful herein include such fat soluble vitamins as A, D, E, and K. Inulin, amino acids, enzymes, coenzymes, and the like may be useful to include in various embodiments.

In various embodiments, the food compositions contain at least one of (1) one or more probiotics; (2) one or more inactivated probiotics; (3) one or more components of inactivated probiotics that promote health benefits similar to or the same as the probiotics, e.g., proteins, lipids, glycoproteins, and the like; (4) one or more prebiotics; and (5) combinations thereof. The probiotics or their components can be integrated into the food compositions (e.g., uniformly or non-uniformly distributed in the compositions) or applied to the food compositions (e.g., topically applied with or without a carrier). Such methods are known to skilled artisans, e.g., U.S. Pat. No. 5,968,569 and related patents.

Typical probiotics include, but are not limited to, probiotic strains selected from Lactobacilli, Bifidobacteria, or Enterococci, e.g., Lactobacillus reuteri, Lactobacillus acidophilus, Lactobacillus animalis, Lactobacillus ruminis, Lactobacillus johnsonii, Lactobacillus casei, Lactobacillus paracasei, Lactobacillus rhamnosus, Lactobacillus fermentum, and Bifidobacterium sp., Enterococcus faecium and Enterococcus sp. In some embodiments, the probiotic strain can be selected from the group consisting of Lactobacillus reuteri (NCC2581; CNCM 1-2448), Lactobacillus reuteri (NCC2592; CNCM 1-2450), Lactobacillus rhamnosus (NCC2583; CNCM 1-2449), Lactobacillus reuteri (NCC2603; CNCM 1-2451), Lactobacillus reuteri (NCC2613; CNCM 1-2452), Lactobacillus acidophilus (NCC2628; CNCM 1-2453), Bifidobacterium adolescentis (e.g., NCC2627), Bifidobacterium sp. NCC2657 or Enterococcus faecium SF68 (NCIMB 10415). The food compositions contain probiotics in amounts sufficient to supply from about 10⁴ to about 10¹² cfu/animal/day, in one aspect, from 10⁵ to about 10¹¹ cfu/animal/day, and in one specific aspect, from 10⁷ to 10¹⁰ cfu/animal/day. When the probiotics are killed or inactivated, the amount of killed or inactivated probiotics or their components should produce a similar beneficial effect as the live microorganisms. Many such probiotics and their benefits are known to skilled artisans, e.g., EP1213970B1, EP1143806B1, U.S. Pat. No. 7,189,390, EP1482811B1, EP1296565B1, and U.S. Pat. No. 6,929,793. In one embodiment, the probiotic can be Enterococcus faecium SF68 (NCIMB 10415). In another embodiment, the probiotics can be encapsulated in a carrier using methods and materials known to skilled artisans.

As stated, the food compositions may contain one or more prebiotics, e.g., fructo-oligosaccharides, gluco-oligosaccharides, galacto-oligosaccharides, isomalto-oligosaccharides, xylo-oligosaccharides, soybean oligosaccharides, lactosucrose, lactulose, and isomaltulose. In one embodiment, the prebiotic can be chicory root, chicory root extract, inulin, or combinations thereof. Generally, prebiotics can be administered in amounts sufficient to positively stimulate the healthy microflora in the gut and cause these “good” bacteria to reproduce. Typical amounts range from about one to about 10 grams per serving or from about 5% to about 40% of the recommended daily dietary fiber for an animal. The probiotics and prebiotics can be made part of the composition by any suitable means. Generally, the agents can be mixed with the composition or applied to the surface of the composition, e.g., by sprinkling or spraying. When the agents are part of a kit, the agents can be admixed with other materials or in their own package. Typically, the food composition contains from about 0.1 to about 10% prebiotic, in one aspect, from about 0.3 to about 7%, and in one specific aspect, from about 0.5 to 5%, on a dry matter basis. The prebiotics can be integrated into the compositions using methods known to skilled artisans, e.g., U.S. Pat. No. 5,952,033.

A skilled artisan can determine the appropriate amount of food ingredients, vitamins, minerals, probiotics, prebiotics, antioxidants, or other ingredients to be used to make a particular composition to be administered to a particular animal. Such artisan can consider the animal's species, age, size, weight, health, and the like in determining how best to formulate a particular composition comprising such ingredients. Other factors that may be considered include the desired dosage of each component, the average consumption of specific types of compositions by different animals (e.g., based on species, body weight, activity/energy demands, and the like), and the manufacturing requirements for the composition.

In a further aspect, the invention provides kits suitable for administering food compositions to animals. The kits comprise in separate containers in a single package or in separate containers in a virtual package, as appropriate for the kit component, one or more of (1) one or more ingredients suitable for consumption by an animal; (2) instructions for how to combine the ingredients and other kit components to produce a composition useful for promoting lean body mass and/or managing weight; (3) instructions for how to use the food composition for promoting lean body mass, minimizing body fat gain, and/or managing weight; (4) one or more probiotics; (5) one or more inactivated probiotics; (6) one or more components of inactivated probiotics that promote health benefits similar to or the same as the probiotics, e.g., proteins, lipids, glycoproteins, and the like; (7) one or more prebiotics; (8) a device for preparing or combining the kit components to produce a composition suitable for administration to an animal; and (9) a device for administering the combined or prepared kit components to an animal. In one embodiment, the kit comprises one or more ingredients suitable for consumption by an animal. In another embodiment, the kit comprises instructions for how to combine the ingredients to produce a composition useful for promoting lean body mass and managing weight.

When the kit comprises a virtual package, the kit is limited to instructions in a virtual environment in combination with one or more physical kit components. The kit contains components in amounts sufficient for promoting lean body mass, minimizing body fat gain, and/or managing weight. Typically, the kit components can be admixed just prior to consumption by an animal. The kits may contain the kit components in any of various combinations and/or mixtures. In one embodiment, the kit contains a container of food for consumption by an animal. The kit may contain additional items such as a device for mixing ingredients or a device for containing the admixture, e.g., a food bowl. In another embodiment, the food compositions can be mixed with additional nutritional supplements such as vitamins and minerals that promote good health in an animal. The components can be each provided in separate containers in a single package or in mixtures of various components in different packages. In some embodiments, the kits comprise one or more other ingredients suitable for consumption by an animal. In one aspect, such kits can comprise instructions describing how to combine the ingredients to form a food composition for consumption by the animal, generally by mixing the ingredients or by applying optional additives to the other ingredients, e.g., by sprinkling nutritional supplements on a food composition.

In a further aspect, the invention provides a means for communicating information about or instructions for one or more of (1) using a food composition for promoting lean body mass and/or managing weight; (2) contact information for consumers to use if they have a question regarding the methods and compositions of the invention; and (3) nutritional information about the food composition. The communication means can be useful for instructing on the benefits of using the invention and communicating the approved methods for administering food compositions to an animal. The means comprises one or more of a physical or electronic document, digital storage media, optical storage media, audio presentation, audiovisual display, or visual display containing the information or instructions. In one aspect, the means can be selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

In another aspect, the invention provides methods for manufacturing a food composition comprising one or more other ingredients suitable for consumption by an animal, e.g., one or more of protein, fat, carbohydrate, fiber, vitamins, minerals, probiotics, prebiotics, and the like. The methods comprise admixing one or more ingredients suitable for consumption by an animal. The composition can be made according to any method suitable in the art.

In another aspect, the invention provides a package useful for containing compositions of the present invention. The package comprises at least one material suitable for containing the food composition and a label affixed to the package containing a word or words, picture, design, acronym, slogan, phrase, or other device, or combination thereof that indicates that the contents of the package contains the food composition. In some embodiments, the label affixed to the package contains a word or words, picture, design, acronym, slogan, phrase, or other device, or combination thereof that indicates that the contents of the package contains the food composition with beneficial properties relating to promoting lean body mass during weight loss. Typically, such device comprises the words “promotes lean body mass and managing weight” or an equivalent expression printed on the package. Any package configuration and packaging material suitable for containing the composition is useful in the invention, e.g., bag, box, bottle, can, pouch, and the like manufactured from paper, plastic, foil, metal, and the like. In one embodiment, the package contains a food composition adapted for a particular animal such as a human, canine, or feline, as appropriate for the label, in one aspect, a companion animal food composition for dogs or cats. In one embodiment, the package can be a can or pouch comprising a food composition of the invention. In various embodiments, the package further comprises at least one window that permit the package contents to be viewed without opening the package. In some embodiments, the window can be a transparent portion of the packaging material. In others, the window can be a missing portion of the packaging material.

### EXAMPLES

The invention can be further illustrated by the following example, although it will be understood that this example is included merely for purposes of illustration and is not intended to limit the scope of the invention unless otherwise specifically indicated.

### Example 1

The physiological effects of the food composition administration were investigated. The food composition was provided to dogs to study the effect on body weight loss and body composition.

In the dog study, thirty adult dogs (2-12 years old) were randomized into two groups based on their baseline maintenance energy requirement (MER), body weight, body fat, age and gender. During the study, all dogs were fed 25% more than there baseline MERs. The administered diets are listed in Table 1. The dogs were administered each diet for 6 months. Body weight was recorded weekly, and body composition was measured monthly by quantitative magnetic resonance (QMR) technology.

TABLE 1

| Ingredients | Test Diet (%) | Control Diet (%) |
|---|---|---|
| Protein | 53.05 | 26.00 |
| Carbohydrate | 10.71 | 40.00 |
| Fat | 16.03 | 15.50 |
| Fiber | 3.86 | 3.80 |
| Protein:CHO | 4.95:1 | 0.65:1 |

At the end of the 12 month study, dogs in the test group gained 3 times less body weight as compared to the control diet (6.2% vs 18.6%). Surprisingly, dogs fed the test diet increased 2.65 times more lean body mass (714.1 g) as compared to the control diet (269.3 g) while minimizing their weight gain (6.2% vs 18.6%) and body fat gain (3.35% vs 14.01%). The data is provided in Table 2 and shows that a diet with a protein to carbohydrate ratio of 4.95:1, promoted lean body mass, and minimized body fat gain while maintaining weight when fed more than an animal's MER.

TABLE 2

| | Average Lean | Average | Average |
|---|---|---|---|
| | Body Mass | Weight Gain | Body Fat |
| | Increase | (% change | (% change |
| | (grams) | from baseline) | from baseline) |
| Dogs Fed The | 269.3 | 18.6 | 14.01% |
| Control Diet | | | |
| Dogs Fed The | 714.1 | 6.2 | 3.35% |
| Test Diet | | | |

### Example 2

In the dog study, thirty adult dogs (2-12 years old) were randomized into two groups based on their baseline maintenance energy requirement (MER), body weight, body fat, age and gender. During the study, all dogs were fed 25% more than there baseline MERs. The administered diets are listed in Table 3. The dogs were administered each diet for 6 months. Body weight was recorded weekly, and body composition was measured bimonthly by DEXA technology.

TABLE 3

| Ingredients | Test Diet (%) | Control Diet (%) |
|---|---|---|
| Protein | 51.67 | 25.05 |
| Carbohydrate | 14.7 | 40.9 |
| Fat | 16.4 | 17.1 |
| Fiber | 3.52 | 4.88 |
| Protein:CHO | 3.5:1 | 0.61:1 |

At the end of the 6 month study, dogs in the test group had same amount of body weight (32.28 kg vs 32.27 kg) and % body fat (29.56% vs 29.52%) as compared to the control diet. The data are provided in Table 4 and show that a diet with a protein to carbohydrate ratio of 3.5:1 failed to prevent body weight gain, and minimize % body fat gain when fed more than an animal's MER.

TABLE 4

| | Baseline | | Body weight | | Baseline | % Body fat |
|---|---|---|---|---|---|---|
| | body | | at the end | | % body | at the end |
| | weight | | of the study | | fat | of the study |
| Dogs Fed The | 28.22 | kg | 32.27 | kg | 21.73% | 29.52% |
| Control Diet | | | | | | |
| Dogs Fed The | 27.98 | kg | 32.28 | kg | 20.54% | 29.56% |

Test Diet

In the specification, there have been disclosed certain embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

What is claimed is:

1. A method for promoting lean body mass, minimizing body fat gain, and maintaining weight without limiting caloric intake, comprising administering to the animal a food composition in an amount more than the animal's baseline maintenance energy requirement (MER), the food composition comprising:
from about 30% to about 65% protein,
from about 10% to about 20% carbohydrate, and
from about 10% to about 25% fat;
wherein the protein and carbohydrate are in a ratio effective for promoting lean body mass, minimizing body fat gain, and maintaining weight during administration of the food composition to the animal.

2. The method of claim 1, further comprising determining the animal's MER by indirect or direct calorimetry.

3. The method of claim 1, wherein promoting lean body mass is measured by measuring the lean body mass of the animal before the administration and measuring the lean body mass after the administration where the lean body mass increases.

4. The method of claim 1, wherein the amount of food composition ranges from greater than about 105% to about 200% of the MER.

5. The method of claim 1, wherein the food composition is administered to the animal on a regular basis.

6. The method of claim 1, wherein the protein comprises about 45% to about 55% of the food composition, the carbohydrate comprises about 10% to about 20% of the food composition, and the fat comprises about 10% to about 20% of the food composition.

7. The method of claim 1, wherein the ratio of protein to carbohydrate ranges from about 4:1 to about 10:1.

8. The method of claim 1, wherein the ratio of protein to carbohydrate ranges from about 4:1 to about 6:1.

9. The method of claim 1, wherein the food composition is a pet food composition.

10. The method of claim 1, wherein the animal is a human or a companion animal.

11. The method of claim 1, wherein the animal is a canine or feline.

12. The method of claim 1, wherein the animal is an obese or overweight animal.

13. A food composition for promoting lean body mass, minimizing body fat gain, and maintaining weight without limiting caloric intake in an animal, comprising:
from about 30% to about 65% protein;
from about 10% to about 20% carbohydrate; and
from about 10% to about 25% fat;
wherein the protein and carbohydrate are in a ratio effective for promoting lean body mass, minimizing body fat gain, and maintaining weight during administration of the food composition to the animal.

14. The food composition of claim 13, wherein the food composition is an extruded dry food composition.

15. The food composition of claim 13, wherein the protein comprises about 45% to about 55% of the food composition, the carbohydrate comprises about 10% to about 20% of the food composition, and the fat comprises about 10% to about 20% of the food composition.

16. The food composition of claim 13, wherein the ratio of protein to carbohydrate ranges from about 4:1 to about 10:1.

17. The food composition of claim 13, wherein the food composition is a pet food composition.

18. The food composition of claim 13, wherein the animal is a human or a companion animal.

19. The food composition of claim 13, wherein the animal is a canine or feline.

20. The food composition of claim 13, wherein the animal is an overweight or obese animal.
